(19) United States
(12) Patent Application Publication
(10) Pub. No.: US 2016/0019119 A1
(43) Pub. Date: Jan. 21, 2016

(54) PRIORITIZING BACKUP OF FILES

(71) Applicant: Longsand Limited, Cambridge (GB)

(72) Inventor: Saurabh Gupta, Bangalore (IN)

(21) Appl. No.: 14/578,178

(22) Filed: Dec. 19, 2014

(30) Foreign Application Priority Data
Jul. 21, 2014 (IN) 3575/CHE/2014

(51) Int. Cl. G06F 11/14; G06F 17/30

(52) U.S. Cl. CPC G06F 11/1451; G06F 17/30088; G06F 2201/84

(57) ABSTRACT

Approaches for prioritizing backup of files are described. In one example, a backup prioritizing parameter for a file shortlisted for backup is identified. Once the backup prioritizing parameter is identified, a position of the file for placing within a backup queue for backup, is subsequently determined based on the backup prioritizing parameter.

### BACKGROUND

With the advent of modern computing, organizations and individuals relying on computing systems for their operations generate large quantities of data in the form of files. The files may be periodically backed-up to ensure that in the event of data loss, the lost data may be recovered from the backed-up data. Backing up of files may be a time intensive process, and therefore, is to be managed and scheduled appropriately to ensure that the files are backed up efficiently.

### BRIEF DESCRIPTION OF THE DRAWINGS

The following detailed description references the drawings, wherein:

FIG. 1A is a block diagram of an example system for prioritizing backup of files;

FIG. 1B is a network environment implementing an example system for prioritizing backup of files;

FIG. 2 is a block diagram of another example system for prioritizing backup of files;

FIG. 3 is a flowchart of an example method for prioritizing backup of files;

FIG. 4 is a flowchart of another example method for prioritizing backup of files; and

FIG. 5 is a block diagram of an example network environment implementing a non-transitory computer-readable medium, for prioritizing backup of files.

### DETAILED DESCRIPTION

Modern computing systems are used widely by organizations for carrying out their operations. During the course of their use, large amounts of data in the form of files, is either created or used. However, the data and files stored in such storage media may still be susceptible to loss or corruption. In the event of the data getting lost or corrupted, the operations of organizations which utilize such data may be affected. In order to ensure that the operations of such organization continue in an uninterrupted manner or with minimal downtime, the data is generally periodically backed up.

Generally, the backup process may be implemented using dedicated systems which manage and coordinate the backup process. For backing up the data, files related to such data may be determined and placed in a backup queue. The backup queue may be considered as a logical arrangement of the files in a specific order in which such files would be backed up. As would be generally understood, the file size of different types of files may vary. For example, files related to documents may be of few megabytes (MB) but the file size of PST files or disk image files (e.g., ISO files) may be of the order of gigabytes (GB). In cases where larger files are also present in the backup queue, the time required for backup would consequently be large. In such a case, considerable time may elapse before the other files in the backup queue are backed up. In cases where the other files are considered as essential, the backup of the larger files may delay the backup or starve the other files preventing their backup in a timely manner. In the event the files are compromised, the relevant data may not get backed up thereby increasing the possibility of the lost data being irretrievable.

Approaches for prioritizing backup of files onto a backup media are described. For backup, one or more files may be shortlisted. In one example, for at least one of the shortlisted files an associated backup prioritizing parameter may be determined. Based on the backup prioritizing parameter, a position or location the backup queue may be determined. For example, depending on the backup prioritizing parameter, a higher position within the backup queue may be determined. In another example, the position of one or more files within the backup queue may be placed lower in the backup queue, such that the other shortlisted files may be backed up earlier.

In operation, a request for backup may be received. Once received, one or more parameters associated with the files which are to be backed up may be determined. In one example, a backup prioritizing parameter associated with the file to be backed up, may be determined. In the present example, the backup prioritizing parameter may be based on one or more attributes associated with the file. For example, the backup prioritizing parameter may include, but is not limited to, file size, file content, file format or file type, frequency of modification or other metadata associated with the files to be backed up. Metadata may include any information associated with the files, for example, information providing identity of the author or owner of the file.

Once the backup prioritizing parameter is determined, one or more prioritizing rules are obtained and executed based on the backup prioritizing parameter. Based on the execution of the prioritizing rules, the order in which the files may be arranged, i.e., the position within the backup queue which may be allocated to the file, is determined. For example, based on the prioritizing rules if one or more files are categorized as high priority, the position of such files may be advanced within the backup queue. In other words, the file under consideration would be allocated a higher position within the backup queue. In such a case, the files with the higher priority would be backed up prior to the other files. As a result, files which are of higher priority may be backed up prior to the other files as they are allocated a higher position within the backup queue. Conversely, if the file is categorized as low priority, the file may be allocated a lower position in the backup queue.

Similarly, the backup prioritizing parameter may also indicate the duration over which the backup of a certain file may occur. In such a case if, based on the prioritizing rules, it is determined that the duration exceeds a predefined threshold, position of such a file within the backup queue may be lowered, and the backup of the file may be deferred. As should be noted, in such a case larger files do not starve or unnecessarily delay the backup of the other, smaller sized files.

The above approaches may be implemented in one or more computing devices which perform backup of desired data. For example, the above mentioned approaches may be implemented by a backup server. While implementing the above mentioned approaches, the backup server may be in communication with one or more other computing devices and data storage over a communication network. The backup server may obtain the files to be backed up from such data storage, and depending on the backup prioritizing parameter and the prioritizing rules, may prioritize the files within the backup queue for backup.

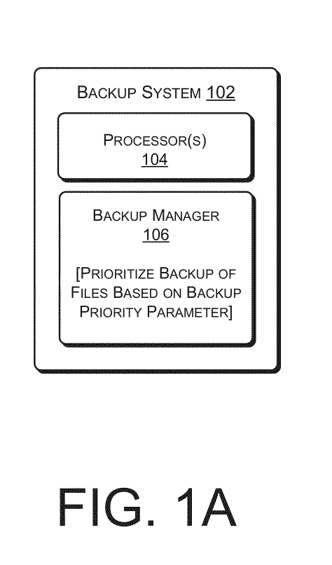

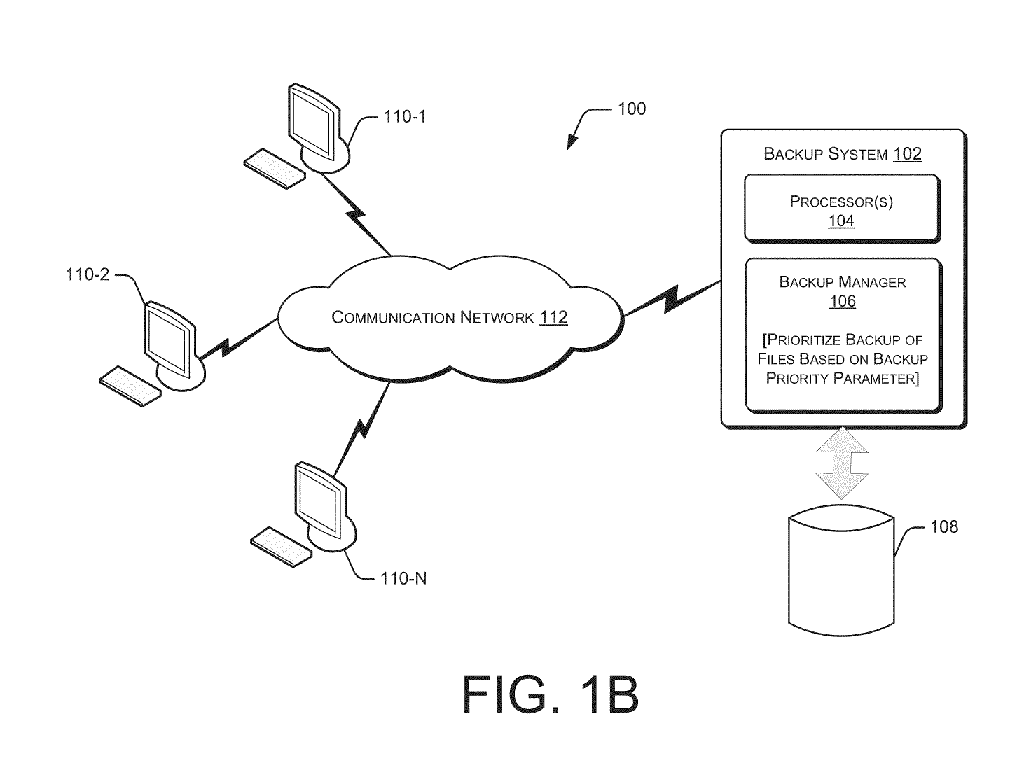

These and other examples are further described herein with reference to FIGS. 1A-1B and FIGS. 2-5. It should be noted that the description and figures relate to example implementations, and should not be construed as a limitation to the present subject matter. It is thus understood that various arrangements may be devised that, although not explicitly described or shown herein, embody the principles of the present subject matter. Moreover, all statements herein reciting principles, aspects, and embodiments of the present subject matter, as well as specific examples, are intended to encompass equivalents thereof.

FIGS. 1A and 1B, respectively, provide a block diagram and a network environment implementing an example backup system 102 for prioritizing backup of files. The backup system 102 may be implemented using servers, or a plurality of computing devices in combination with each other. The backup system 102 may be deployed within an organization having a network based system for implementing backups of data stored in data storage. In the present example as illustrated in FIG. 1A, the backup system 102 may further include processor(s) 104 and a backup manager 106. The processor(s) 104 may be implemented as microprocessors, microcomputers, microcontrollers, digital signal processors, central processing units, state machines, logic circuitries, and/or any devices that manipulate signals based on operational instructions. The functions of various elements shown in FIG. 1A, including a functional block labeled as “processor(s)”, may be provided through the use of dedicated hardware as well as hardware capable of executing machine readable instructions. The backup system 102 through the backup manager 106 implements prioritizing backup of files based on a backup prioritizing parameter.

FIG. 1B further illustrates a network environment 100 for prioritizing backup of files. As shown in FIG. 1B, the backup system 102 is further coupled to data storage 108 and one or more computing device(s) 110-1, 2, . . . , n. The data storage 108 stores the data that is generated by the computing device(s) 110-1, 2, . . . , n (collectively referred to as computing devices 110). The backup system 102 may be in communication with the computing devices 110 through a communication network 112. Although shown as being directly coupled to the data storage 108, the backup system 102 may be in communication with the data storage 108 over the communication network 112. The data within the data storage 108 may be stored in the form of plurality of files. For backing up data, the files within the data storage 108 are determined and subsequently backed up.

The communication network 112 may be a wireless network, a wired network, or a combination thereof. The communication network 112 can also be an individual network or a collection of many such individual networks, interconnected with each other and functioning as a single large network, e.g., the Internet or an intranet. The communication network 112 can be implemented as one of the different types of networks, such as intranet, local area network (LAN), wide area network (WAN), and the internet. The communication network 112 may either be a dedicated network or a shared network, which represents an association of the different types of networks that use a variety of protocols, for example, Hypertext Transfer Protocol (HTTP), and Transmission Control Protocol/Internet Protocol (TCP/IP), to communicate with each other. In an example implementation, the communication network 112 may include a Global System for Mobile Communication (GSM) network, a Universal Mobile Telecommunications System (UMTS) network, or any other communication network that use any of the commonly used protocols, for example, Hypertext Transfer Protocol (HTTP) and Transmission Control Protocol/Internet Protocol (TCP/IP).

Returning to the backup system 102, in operation, instructions for initiating the backup process may be received by the backup system 102. Based on the received instructions, the backup manager 106 may further identify and shortlist the files which are to be backed up. Once identified, the backup manager 106 may further determine one or more backup prioritizing parameters associated with the files which are to be backed up.

In one example, the backup prioritizing parameter may include file size, file content, file format or file type, frequency of modification or other metadata associated with the files to be backed up. Besides such types of information, any other information prescribed to such files may used as the backup prioritizing parameters, without deviating from the scope of the present subject matter. Subsequently, one or more prioritizing rules may be further obtained. The prioritizing rules may either be obtained from a predefined repository or may be provided by a user at the time of initiating the backup. For example, the prioritizing rules may be provided by a backup administrator through any one of the computing devices 110. In such a case, the backup administrator may either define such prioritizing rules or store the same in the predefined repository. Alternatively, the backup administrator may provide one or more prioritizing rules at the time of initiating the backup. In one example, the prioritizing rules may be selected based on the information within the backup prioritizing parameter.

Once the prioritizing rules are obtained, the backup manager 106 prioritizes the files. In order to prioritize the files for backup, the backup manager 106 determines an order in which the relevant files are to be arranged within a backup queue. For prioritizing, the backup manager 106 may execute the prioritizing rules based on the backup prioritizing parameters. Based on the execution of the prioritizing rules, the backup manager 106 may determine the order in which the one or more files have to be arranged in the backup queue.

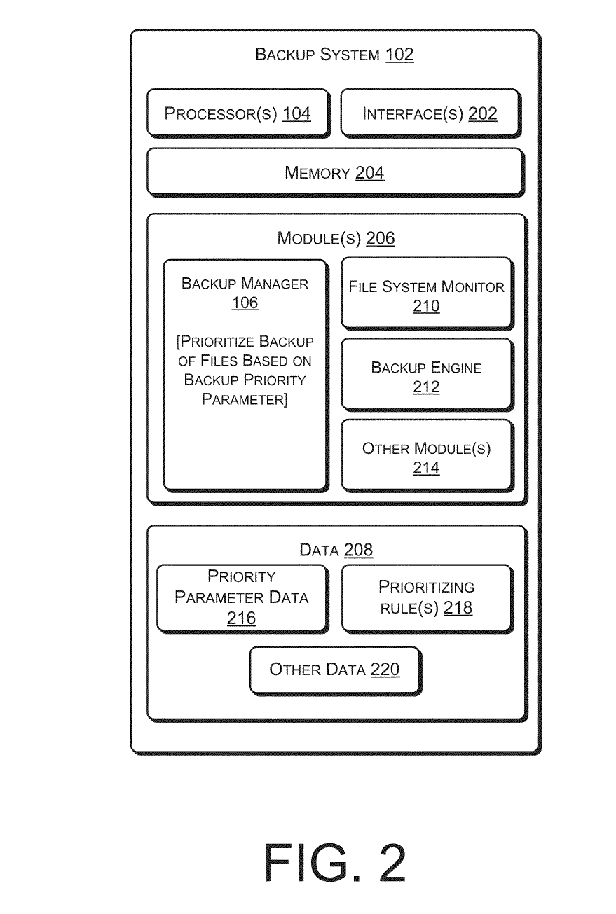

Using the present approach, the files for backup may be prioritized for backup. For example, if based on the backup prioritizing parameter the backup manager 106 categorizes the file as having higher priority, the position of the same may be advanced when allocated within the backup queue. For example, within the backup queue, the file having the higher priority would be allocated, i.e., positioned higher in the backup queue. Similarly, if it is determined that deferring backup of a specific file would benefit the backing up of the other files in the backup queue, the position of the specific file within the backup queue may be lowered when allocated within the backup queue. For example, backup of specific files which are of a large file size may be deferred and may be completed after other files have been backed up. These and other examples are further explained in detail in conjunction with FIG. 2.

FIG. 2 illustrates an example backup system 102 for prioritizing backup of files. The backup system 102 may be implemented as a combination of servers, or other computing devices. The backup system 102 includes processor(s) 104, interface(S) 202 and memory 204. The processor(s) 104 may also be implemented as signal processor(s), state machine(s), logic circuitries, and/or any other device or component that manipulate signals based on operational instructions.

The interface(s) 202 may include a variety of interfaces, for example, interfaces for data input and output devices, referred to as I/O devices, storage devices, network devices, and the like, for communicatively associating the backup system 102 with one or more computing devices, such as computing devices 110, and data storage 108 (not shown in FIG. 2). The interface(s) 202 facilitate communication between the backup system 102 and various other computing devices connected in a network environment, such as the network environment 100. The memory 204 may store one or more computer-readable instructions, which may be fetched and executed so as to cause to provide front-to-back registration of a printed content onto a print medium. The memory 204 may include any non-transitory computer-readable medium including, for example, volatile memory, such as RAM, or non-volatile memory such as EPROM, flash memory, and the like.

The backup system 102 may further include module(s) 206 and data 208. The module(s) 206 may be implemented as a combination of hardware and programming (e.g., programmable instructions) to implement one or more functionalities of the module(s) 206. In one example, the module(s) 206 include a backup manager 106 and file system monitor 210. The backup system 102 may further include a backup engine 212 and other module(s) 214 for implementing functionalities that supplement applications or functions performed by the backup system 102.

In examples described herein, such combinations of hardware and programming may be implemented in a number of different ways. For example, the programming for the module(s) 206 may be processor executable instructions stored on a non-transitory machine-readable storage medium and the hardware for the module(s) 206 may include a processing resource (e.g., one or more processors), to execute such instructions. In the present examples, the machine-readable storage medium may store instructions that, when executed by the processing resource, implement module(s) 206 or their associated functionalities. In such examples, the backup system 102 may include the machine-readable storage medium storing the instructions and the processing resource to execute the instructions, or the machine-readable storage medium may be separate but accessible to backup system 102 and the processing resource. In other examples, module(s) 206 may be implemented by electronic circuitry.

In operation, the backup system 102 receives requests for initiating the backup process. The requests may be received from users of any one or more of the computing devices 110. On receiving the request, the backup manager 106 identifies the relevant files which have to be backed up. In one example, the files may be identified from amongst a plurality of files stored in the data storage 108. The files for backing up may be further determined based on the requests received by the backup system 102.

Once identified, the file system monitor 210 may determine whether the entire file has to be backed up or not. For example, it may be the case that the file under consideration may have been backed up in the previous backup cycle. In such a case, the file system monitor 210 may further determine whether any changes have been affected to the file under consideration. Such a determination may be further based on determining whether either the content of the file or the metadata of the file as been changed. In the present example, the file system monitor 210 may determine a hash of the corresponding metadata or the content of the files. Based on whether the hash data has changed, the file system monitor 210 may ascertain that modifications to the files have been affected and may shortlist the same for backup. In another example, only the incremental changes affected onto the file would be backed up. In case the file has not been backed up previously, the file system monitor 210 may consider the entire file to be backed up. Similarly, if no changes have been made to the file, the file may not be considered for backing up again.

Subsequently the file system monitor 210 may shortlist the files for backup. For the shortlisted set of files, the backup manager 106 may further determine one or more backup prioritizing parameters which may be associated with the file. In an example implementation, the backup prioritizing parameters may also be stored as prioritizing parameter data 216 in data 208 of the backup system 102. Examples of backup prioritizing parameter may include file content, file size, file type, frequency of modification or other metadata associated with the files to be backed up. In one example, the backup prioritizing parameter may be determined based on information associated with the respective files. In another example, the backup prioritizing parameter may further be further specified by a backup administrator. For example, the backup administrator may specify that the priority of the file as high.

Once the backup prioritizing parameters associated with the files are determined, the backup manager 106 may further utilize one or more prioritizing rule(s) 218 for prioritizing the files for backup. The prioritizing rule(s) 218 may be either predefined or may be specified by the backup administrator. In case the prioritizing rule(s) 218 are predefined, they may be stored in a rule repository and fetched by the backup manager 106. The prioritizing rule(s) 218 may be based on one or more policy level decisions implemented by the organization for prioritizing backup of files.

The prioritizing rule(s) 218 may specify one or more prioritizing actions based on which the files are to be prioritized. Prioritizing action may include determining the position at which one or more files would be placed within a backup queue. For example, a prioritizing action may prescribe that a specific file is to be positioned at the very first position within the backup queue. When the prioritizing rule(s) 218 are satisfied, the appropriate prioritizing action is implemented. Accordingly the files are prioritized in accordance with the prioritizing rule(s) 218 and the associated prioritizing actions prescribed therein. The appropriate prioritizing action to be taken would depend on the backup prioritizing parameter. Depending on the backup prioritizing parameter, the prioritizing rule(s) 218 may be executed and the appropriate prioritizing action would be implemented.

Returning to the process for prioritizing backup of files, the prioritizing rule(s) 218 are selected, say by a backup administrator. In another example, the prioritizing rule(s) 218 may be selected by the backup manager 106 based on input received from any of the computing devices 110. Once the relevant prioritizing rule(s) 218 are identified, the same may be executed based on the one or more backup prioritizing parameters. Once the prioritizing rule(s) 218 are executed, the relevant prioritizing actions as prescribed by the prioritizing rule(s) 218 may be implemented for prioritizing backup of files.

For prioritizing, the backup manager 106 may generate a backup queue. Depending on the prioritizing actions, the backup manager 106 may determine the order in which the files may be arranged within the backup queue. For example, the backup manager 106 may prioritize backup of files by positioning them higher in the backup queue. In this case, files which are placed at earlier or higher positions within the backup queue would be backed up first. Similarly, for some of the files, based on the prioritizing action, the backup manager 106 may position one or more files at a lower position within the backup queue. Consequently, the backup of such files is deferred, and such would be backed up after the other files positioned higher in the backup queue have been backed up.

Certain example implementation to further describe prioritizing backup of files are provided. However, the same are only illustrations and should not be considered as limiting the scope of the present subject matter. In one example, the backup prioritizing parameter may be file type or file format. A file format may specify the type of file, for example, whether the file is a text file, an image file, an audio file, and so on. Furthermore, one or more prioritizing rule(s) 218 are further determined for prioritizing backup of files. The prioritizing rule(s) 218, in the present example, may determine the manner in which the backup of the files is to be prioritized based on the file format. For example, the prioritizing rule(s) 218 may prescribe that the text files or image files should be backed up first. In such a case, the backup manager 106 determines based on the prioritizing rule(s) 218 which of the files identified for backup, are text files and/or image files. Once the appropriate files are identified, the backup manager 106 generates the backup queue and places the identified text files and/or image files at higher positions in the backup queue. The remaining of the shortlisted files may be placed in the backup queue in any order, thereafter.

In another example, the backup prioritizing parameter may be file size. As would be generally understood, the duration required for backing up a file would be directly dependent on its file size. Consequently, larger sized files would require more time for being backed up as compared to other files. In such a scenario the backup of such large files may starve or delay the backup of other files which may be present in the backup queue. Returning to the present subject matter, one or more prioritizing rule(s) 218 may specify that the backup of files having large size may be deferred. In the present example, the prioritizing rule(s) 218 may specify a predefined threshold. The backup manager 106 may further compare the file size of the shortlisted files for backup, with the predefined threshold. In case the backup manager 106 determines that the file size of any one or more files is greater than the predefined threshold, the backup manager 106 may place such flies at a lower position within the backup queue. This allows other files to be backed up prior to the larger sized files.

It may also occur that such large sized files are routinely placed at lower positions within the backup queue. In another example, the number of times the backup of the file has been deferred, i.e., the number of times the file has been allocated a lower position in the backup queue, is determined. If the number exceeds a predefined limit, the backup manager 106 may not further position the larger sized file again within the backup queue.

In yet another example, the backup prioritizing parameter may indicate a priority associated with the file. The priority may be user prescribed or may be based on any other parameter. For example, the priority may be prescribed based on an application which has created the file. The backup manager 106 may further then place the file at a higher position within the backup queue. In another example, if each of the files shortlisted for backup are associated with a priority, the backup manager 106 may arrange the files within the backup queue based on the associated priority. In yet another example, each of the shortlisted files may be associated with a priority. Accordingly, for prioritizing backup of files, the backup manager 106 may arrange the files based on a descending order of priority.

As can be gathered from above, different backup prioritizing parameters may be used for prioritizing backup of files. Depending on other backup prioritizing parameter, i.e., based on the prioritizing parameter data 216, the prioritizing rule(s) 218 may be executed for further prioritizing backup of files. The above mentioned example implementations provide various approaches for prioritizing backup of files. However the same are only provided as illustrations and should not be construed as limiting the scope of the present subject matter.

Once the backup manager 106 generates the backup queue, the backup engine 212 initiates the backup process for the files present within the backup queue. As would be appreciated, since the files within the backup queue have been prioritized, the files are backed up in an efficient manner. For example, the files categorized higher priority or with greater sensitivity may be identified and accordingly they may be prioritized within the backup queue for backup. Similarly, files which may starve backup of other files, may be positioned at lower position within the backup queue thereby deferring the backup of such files.

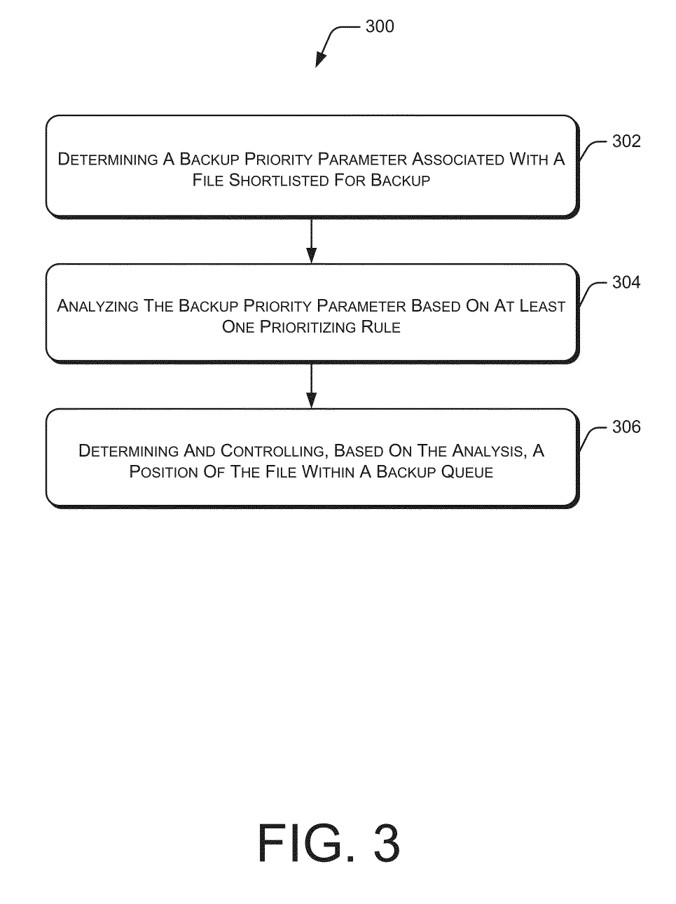

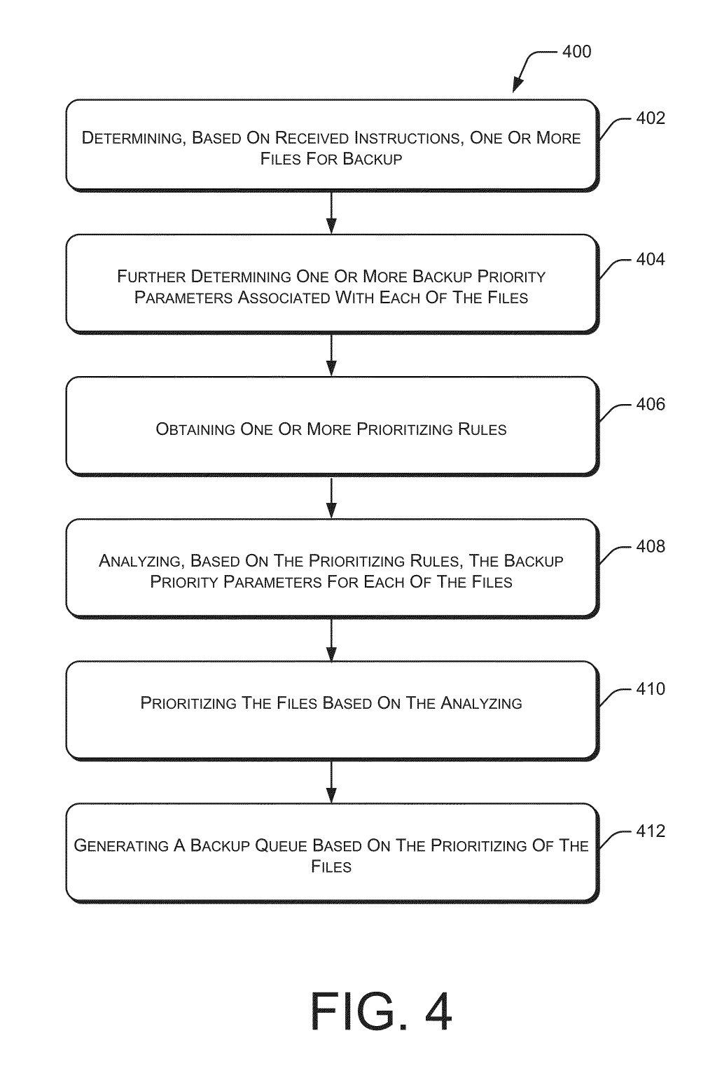

FIGS. 3 and 4 illustrate example methods 300 and 400, respectively, for prioritizing backup of files, according to an implementation of the present subject matter. The order in which the methods are described is not intended to be construed as a limitation, and any number of the described method blocks may be combined in any order to implement the aforementioned methods, or an alternative method. Furthermore, methods 300 and 400 may be implemented by processing resource or computing device(s) through any suitable hardware, non-transitory machine readable instructions, or combination thereof.

It may also be understood that methods 300 and 400 may be performed by programmed computing devices, such as the backup system 102 as depicted in FIGS. 1A-1B, and FIG. 2. Furthermore, the methods 300 and 400 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. Although, the methods 300 and 400 are described below with reference to the backup system 102 as described above, other suitable systems for the execution of these methods can be utilized. Additionally, implementation of these methods is not limited to such examples.

At block 302, a backup prioritizing parameter associated with a file is determined. For example, the backup manager 106 may shortlist a plurality of files for backup. For each of the files, backup prioritizing parameter may be determined. Examples of backup prioritizing parameter, such as backup prioritizing parameter, include but are not limited to, file format or file type, file content, frequency of modification or metadata associated with the file. In one example, the backup prioritizing parameter is stored as prioritizing parameter data 216.

At block 304, the backup prioritizing parameter is analyzed based on at least one prioritizing rule. For example, on determining the relevant backup prioritizing parameter, the backup manager 106 may further analyze the backup prioritizing parameter based on the prioritizing rule(s) 218. For analysis, the prioritizing rule(s) 218 may be executed using the prioritizing parameter data 216,

At block 306, based on the analysis, position of the file within a backup queue may be determined and controlled. For example, the prioritizing rule(s) 218 may prescribe one or more prioritizing actions. Upon execution of the prioritizing rule(s) 218 based on the backup prioritizing parameter, the appropriate prioritizing actions may be determined. Accordingly, the backup manager 106 determines the manner in which the files are to be arranged within the backup queue. In one example, depending on the backup prioritizing parameter, the file may be positioned either at the top of the backup queue, or may be placed in lower within the backup queue. Subsequently, the backup manager 106 may generate the backup queue. Based on the backup queue, the backup engine 212 may initiate the backup process.

FIG. 4 provides another example method 400 for prioritizing backup of files. At block 402, based on instructions, one or more files for backup are determined. For example, the backup manager 106 may receive the instructions for initiating the backup process. Based on the instructions, one or more files may be shortlisted for backup. In one example, the file system monitor 210 may determine whether any modifications have been made to the files either with reference to a specific instant of time or since the last backup. On determining, the file system monitor 210 identifies and shortlists the relevant files which have been modified for backup. The files for backup may be obtained from the data storage 108.

At block 404, one or more backup prioritizing parameters associated with each of the files may be determined. For example, the backup prioritizing parameters may include file format or file type, file content, file size, frequency of modification or other metadata associated with the files to be backed up. Metadata may include any information associated with the files, for example, information providing identity of the author or owner of the file. In another example, the backup prioritizing parameter may further be a prescribed priority. The priority may be assigned by either a user or may be defined using one or more rules. The backup prioritizing parameter may be stored as prioritizing parameter data 216.

At block 406, one or more prioritizing rules are obtained. For example, the prioritizing rule(s) 218 may specify one or more prioritizing actions based on which the files are to be prioritized. The prioritizing actions may include determining the position at which one or more files within a backup queue would be placed. Prioritizing actions may prescribe that a specific file is to be positioned at the first location or any later position within the backup queue. When the prioritizing rule(s) 218 are satisfied the appropriate prioritizing action is implemented and the files prioritized in accordance with the prioritizing rule(s) 218 and the prioritizing actions prescribed therein. The prioritizing rule(s) 218 may be further based on one or more policy considerations implemented by an organization.

At block 408, based on the prioritizing rules the backup prioritizing parameters are analyzed. For example, the backup manager 106 may further analyze the prioritizing parameter data 216 associated with the backup prioritizing parameter based on the prioritizing rule(s) 218. In the present example, the backup manager 106 may retrieve and analyze the prioritizing parameter data 216. For analysis, the prioritizing rule(s) 218 are executed based on the prioritizing parameter data 216. Accordingly, the appropriate prioritizing actions are determined and implemented for files shortlisted for backup.

At block 410, the files are prioritized. For example, based on the prioritizing actions, the backup manager 106 may further determine the order in which the shortlisted files are to be arranged for providing within the backup queue. In accordance with the prioritizing rule(s) 218 and the prioritizing parameter data 216, the backup manager 106 may further determine whether the position of the files should be higher or lower. As per one example, in case the backup prioritizing parameter is file size, the backup manager 106 may compare the file size of the shortlisted files with a predefined threshold (e.g., as specified in the prioritizing rule(s) 218). On determining the file size to be greater than the predefined threshold, the backup manager 106 may allocate the files for which the file size is greater than the predefined threshold, to either the last or any lower position in the backup queue. Similarly, the backup manager 106 may, based on the file format or priority (as the backup prioritizing parameter), determine a position at the beginning of the backup queue, and allocate the file to the determined position in the backup queue accordingly.

At block 412, based on the prioritizing of the files a backup queue is generated. For example, the backup queue may be generated by the backup manager 106. Once the backup queue has been generated, the backup engine 212 utilizes the backup queue for initiating the backup of the files.

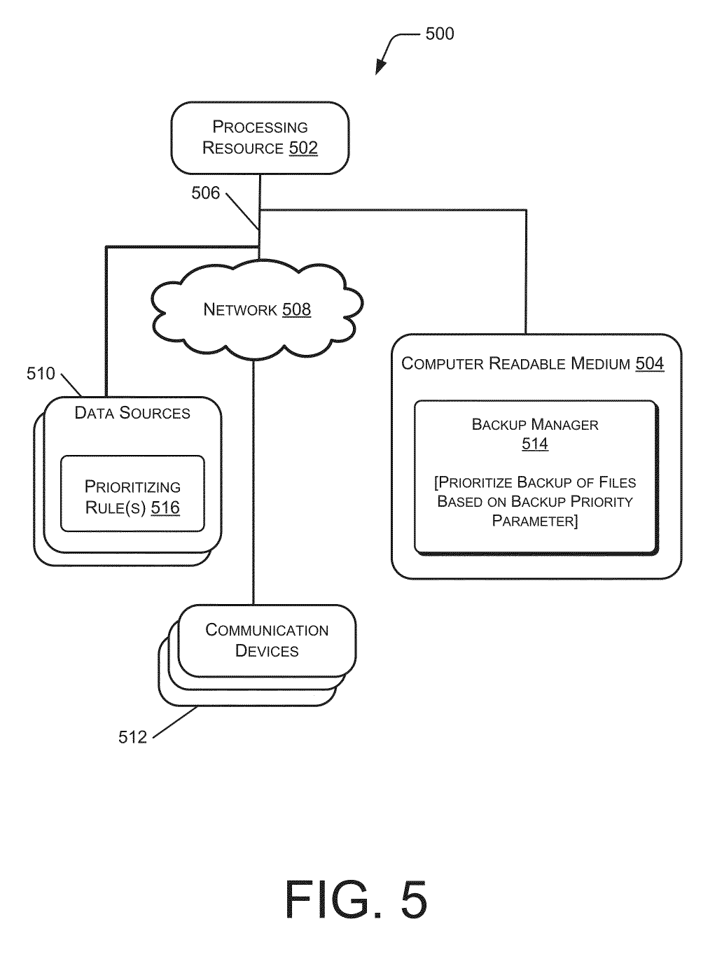

FIG. 5 illustrates a system environment 500 for prioritizing backup of files, according to an example of the present disclosure. The system environment 500 may comprise at least a portion of a public networking environment or a private networking environment, or a combination thereof. In one implementation, the system environment 500 includes a processing resource 502 communicatively coupled to a computer readable medium 504 through a communication link 506.

For example, the processing resource 502 can include one or more processors of a computing device, such as processor(s) 104 of backup system 102, for prioritizing backup of files. The computer readable medium 504 can be, for example, an internal memory device of the computing device or an external memory device. In one implementation, the communication link 506 may be a direct communication link, such as any memory read/write interface. In another implementation, the communication link 506 may be an indirect communication link, such as a network interface. In such a case, the processing resource 502 can access the computer readable medium 504 through a network 508. The network 508 may be a single network or a combination of multiple networks and may use a variety of different communication protocols.

The processing resource 502 and the computer readable medium 504 may also be coupled to data sources 510 through the communication link 506, and/or to communication devices 512 over the network 508. The coupling with the data sources 510 enables in receiving the data in an offline environment, and the coupling with the communication devices 512 enables in receiving the data in an online environment.

In one implementation, the computer readable medium 504 includes a set of computer readable instructions, implementing a backup manager 514. The set of computer readable instructions can be accessed by the processing resource 502 through the communication link 506 and subsequently executed to process data communicated with the data sources 510 in order for prioritizing backup of files. When executed by processing resource 502, the instructions of the backup manager 514 may perform the functionalities described above in relation to the backup system 102.

For example, instructions for backing up one or more file stored in data repository, such as data storage 108, may be received. Based on instructions, the backup manager 514 may identify the relevant files and prepare a list of files which are shortlisted for backup. For example, the backup manager 106 may receive the instructions for initiating the backup process. Based on the instructions, one or more files may be shortlisted for backup.

Subsequently, the backup manager 514 may further determine one or more backup prioritizing parameters associated with each of the files which have been shortlisted for backup. In one example, prioritizing parameter data associated with backup prioritizing parameters may be stored in data sources 510. The backup prioritizing parameters may include file format or file type, file content, file size, frequency of modification or other metadata associated with the files to be backed up. Once the backup prioritizing parameters are determined, the backup manager 514 may further determine one or more prioritizing rules. The rules may be available as prioritizing rule(s) 516 within data sources 510.

The prioritizing rule(s) 516 may specify one or more prioritizing actions, such as determining the relative position of the files, for placing within a backup queue. Upon conformance with the prioritizing rule(s) 516, the appropriate prioritizing action is performed by the backup manager 514.

The backup manager 514 may further implement analyzing the backup prioritizing parameters based on the prioritizing rule(s) 516. In one example, the backup manager 514 may further analyze the backup prioritizing parameters by executing the prioritizing rule(s) 516 based on the prioritizing parameter data (such as prioritizing parameter data 216) associated with the backup prioritizing parameters. Accordingly, the appropriate prioritizing actions are determined and implemented for files shortlisted for backup. Based on the execution of the prioritizing rule(s) 516, the shortlisted files are prioritized. For example, based on the prioritizing actions, the backup manager 514 may further determine the order in which the shortlisted files are to be arranged within the backup queue. Subsequently, a backup queue may be generated by the backup manager 514. Once generated, the backup queue is used for initiating the backup of the files.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

I/We claim:

1. A method for prioritizing backup of a file, the method comprising:
determining a backup prioritizing parameter associated with a file from amongst a plurality of files shortlisted for backup, wherein the backup prioritizing parameter is based on a duration over which backup of the file spans;
analyzing the backup prioritizing parameter based on a prioritizing rule specifying a predefined threshold; and
determining a position of file for allocation within a backup queue based on the analyzing.

2. The method as claimed in claim 1, wherein the determining the position of the file further comprises determining a relative position of the file with respect to other files from amongst the plurality of files for allocation within the backup queue, wherein the file is allocated the position in the backup queue after the other files.

3. The method as claimed in claim 2, further comprising deferring the backup of the file, the deferring comprising:
based on the determining the relative position of the file, generating the backup queue; and
initiating the backup of the plurality of files shortlisted for backup based on the backup queue, wherein the file is backed up after the other files.

4. The method as claimed in claim 1, the method further comprising:
determining a backup prioritizing parameter of another file from amongst the plurality of files shortlisted for backup; and
based on the backup prioritizing parameter of the another file, determining position for the another file within the backup queue such that the another file is positioned before the plurality of remaining files within the backup queue for backup.

5. The method as claimed in claim 1, wherein the backup prioritizing parameter is based on the size of the file.

6. The method as claimed in claim 2, the method further comprising:
determining a priority based on backup prioritizing parameter for each of the plurality of other files within the backup queue; and
sorting each of the plurality of the other files within the backup queue based on the priority for each of the plurality of the other files.

7. A system for prioritizing backup of a file, the system comprising:
a processor;
a backup manager coupled to the processor, wherein the backup manager is to,
determine a backup prioritizing parameter for a file within a backup queue;
analyze the backup prioritizing parameter based on at least one prioritizing rule; and
based on the analysis and the prioritizing rule, prioritize the backup of the file by determining position of the file within the backup queue.

8. The system as claimed in claim 7, the system further comprising a file system monitor coupled to the processor, wherein the file system monitor is to,
determine whether the file has been modified; and
on determining that the file has been modified, shortlist the file for backup.

9. The system as claimed in claim 7, wherein the backup manager is to further categorize the file as one of high priority or low priority, based on the backup prioritizing parameter.

10. The system as claimed in claim 9, wherein for the file categorized as high priority, the backup manager is to allocate the file a higher position within the backup queue.

11. The system as claimed in claim 7, wherein the backup prioritizing parameter is one of file size, file type, file content, and frequency of modifications.

12. The system as claimed in claim 11, wherein for the backup prioritizing parameter being file size, the backup manager is to further,
determine a duration over which backup of the file spans for the corresponding file size;
compare the duration with a predefined threshold; and
defer the backup of the file based on the comparing.

13. The system as claimed in claim 12, wherein the backup manager is to further,
determine a relative position of the file with respect to plurality of other files within the backup queue; and
organize the file for the backup queue such that the file on being placed, is positioned after the plurality of other files, within the backup queue for backup.

14. A non-transitory computer-readable medium comprising instructions executable by a processing resource to:
determine a backup prioritizing parameter for a file shortlisted for backup; and
based on the backup prioritizing parameter, determine a position of the file for placing within a backup queue for backup.

15. The computer-readable medium of claim 14, wherein the backup prioritizing parameter is one of file size, file type, file content, and frequency of modifications.
